(19) United States
(12) Patent Application Publication
(10) Pub. No.: US 2011/0063967 A1
(43) Pub. Date: Mar. 17, 2011

(54) OPTICAL PICKUP DEVICE AND OPTICAL DISC APPARATUS USING THE SAME

(76) Inventors: Toshiteru NAKAMURA, Yokohama (JP); Kazuyoshi Yamazaki, Yamato (JP)

(21) Appl. No.: 12/760,588

(22) Filed: Apr. 15, 2010

(30) Foreign Application Priority Data
Sep. 11, 2009 (JP) 2009-209966

(51) Int. Cl. G11B 7/135

(52) U.S. Cl. 369/112.03; G9B/7.112

(57) ABSTRACT

A diffractive optical element having a diffraction region for diffracting a part of a luminous flux is mounted and an unwanted luminous flux generated in a multi-layer optical disc is suppressed from entering a photodetector surface. Using the above-described structure, fluctuation of a tracking error signal can be suppressed from being caused by the unwanted luminous flux and preferable recording or reproduction quality can be obtained also in the multi-layer optical disc.

### INCORPORATION BY REFERENCE

The present application claims priority from Japanese application JP2009-209966 filed on Sep. 11, 2009, the content of which is hereby incorporated by reference into this application.

### BACKGROUND OF THE INVENTION

The present invention relates to an optical pickup device and an optical disc apparatus using the same.

As a background art of this technical field, for example, JP-A-2005-203090 is disclosed. In this publication, disclosed is a problem to be solved where “provided is an optical pickup device that can suppress interference light caused by adjacent layers and improve fluctuation of tracking error signals detected by a DPP method when recording and/or reproducing data onto and/or from a multi-layer optical disc that has a plurality of recording layers on one side”. Further, disclosed is a solution where “this optical pickup device has an optical component that suppresses the interference light caused by the adjacent layers from being received by a photodetector when applied to an optical information recording medium that has at least a plurality of recording layers on one surface”. Also, disclosed is a solution wherein “this makes it possible to suppress the interference light caused by the adjacent layers from being received by the photodetector, especially by first and second sub photodetectors of the photodetector”.

### SUMMARY OF THE INVENTION

A problem to be solved by the present invention is that in recent years, when recording and/or reproducing data onto and/or from an optical disc in which recording layers are multilayered, an unwanted luminous flux reflected by a recording layer not to be reproduced enters a photodetector surface to become disturbance components, thereby fluctuating a detection signal of the photodetector. In the multi-layer optical disc having three or more recording layers, particularly, since unwanted luminous fluxes are caused by a plurality of layers, disturbance components are increased to remarkably increase fluctuation of the detection signals.

In view of the foregoing, it is an object of the present invention to provide an optical pickup device and optical disc apparatus that reduce leakage to the detection signals by the disturbance components caused by the unwanted luminous flux and obtain stable recording or reproduction quality with high quality.

The above-described object can be accomplished by the invention recited in a scope of patent claim as one example.

To accomplish the above-described object, according to one aspect of the present invention, there are provided an optical pickup device and optical disc apparatus that can reduce an influence on the detection signals due to the disturbance components caused by the unwanted luminous fluxes and detect signals with high quality.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic view illustrating an optical system structure of an optical pickup device according to the present embodiment of the invention;

FIG. 2 is a schematic view illustrating a conventional example and signal operation method of a photodetector;

FIG. 3 is a schematic view illustrating an optical path of a luminous flux made incident on a dual-layer optical disc;

FIG. 4A is a schematic view illustrating a conventional example of a diffraction region shape of a diffractive optical element;

FIG. 4B is a schematic view illustrating a light intensity distribution of a signal luminous flux and unwanted luminous flux on a photodetector at the time of mounting the diffractive optical element in FIG. 4A of a dual-layer optical disc;

FIG. 5 is a schematic view illustrating an optical path of a luminous flux made incident on a multi-layer optical disc;

FIG. 6 is a schematic view illustrating a light intensity distribution of a signal luminous flux and unwanted luminous flux on the photodetector at the time of mounting the diffractive optical element in FIG. 4A of the multi-layer optical disc;

FIG. 7A is a schematic view illustrating a diffraction region shape of the diffractive optical element as a principal part according to a first embodiment;

FIG. 7B is a schematic view in which a PP signal region is collectively written in the diffractive optical element illustrated in FIG. 7A;

FIG. 7C is a schematic view illustrating a light intensity distribution of a signal luminous flux and unwanted luminous flux on the photodetector at the time of mounting the diffractive optical element in FIG. 7A of the dual-layer optical disc;

FIGS. 8A to 8D are schematic views illustrating typical examples of diffraction region shapes of the diffractive optical element;

FIGS. 9A to 9D are schematic views in which the PP signal regions are collectively written in the diffractive optical elements illustrated in FIGS. 8A to 8D;

FIG. 10 is a schematic view illustrating a signal operation method and the photodetector as a principal part according to the first embodiment;

FIG. 11 is a schematic view illustrating the signal operation method and the photodetector as a principal part according to a second embodiment;

FIG. 12 is a schematic view illustrating the signal operation method and a modification example of the photodetector as a principal part according to the second embodiment;

FIG. 13 is a schematic view illustrating the signal operation method and the photodetector as a principal part according to a third embodiment;

FIG. 14 is a schematic view illustrating the signal operation method and a modification example of the photodetector as a principal part according to the third embodiment; and

FIG. 15 is a schematic view illustrating one example of an optical disc apparatus having mounted thereon the optical pickup device according to the first to third embodiments.

### DETAILED DESCRIPTION OF THE EMBODIMENTS

Hereinafter, preferred embodiments of the present invention will be described in detail with reference to the accompanying drawings of the embodiments. Furthermore, in each figure, the same reference numerals are attached to the constituent elements performing the same action.

### Embodiment 1

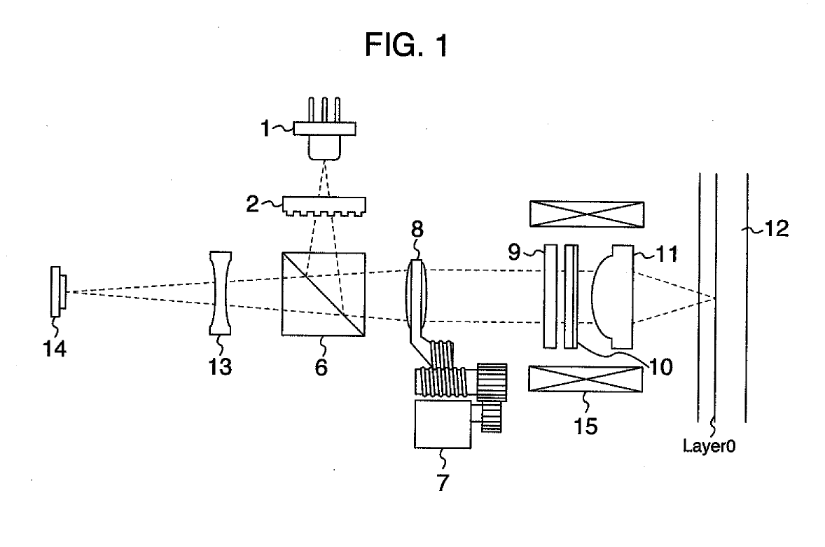

FIG. 1 is a schematic view illustrating one example of an optical pickup device according to a first embodiment of the invention.

A laser luminous flux 1 emitted from a laser light source is made incident on a diffraction grating as a luminous flux dividing element. The laser luminous flux 1 is divided into a main luminous flux 3 including 0th-order diffracted light and two sub-luminous fluxes 4 and 5 including positive 1st-order diffracted light and negative 1st-order diffracted light. A traveling direction of each luminous flux is changed by a polarized beam splitter 6. Each luminous flux passes through a collimating lens 8 capable of correcting a spherical aberration of an incident luminous flux by the driving of a stepper motor 7, a diffractive optical element 9 including a diffraction region that diffracts a part of the main luminous flux and the sub-luminous fluxes, and a quarter wave plate 10 that gives a phase difference of 90 degrees to two polarization components orthogonal to each other. Then, each luminous flux is independently converged on a predetermined recording layer within an optical disc 12 by an objective lens 11. A reflected luminous flux from the optical disc of each converged light spot is transmitted to the objective lens 11 again, and then, passes through the quarter wave plate 10, the diffractive optical element 9, the collimating lens 8, the polarized beam splitter 6, and an astigmatism generating unit 13, and enters a photodetector 14. In addition, the objective lens 11, the quarter wave plate 10, and the diffractive optical element 9 may be installed within an actuator 15 for driving them to a predetermined direction. A tracking error signal described later is fed back to this actuator 15, and position control of the objective lens 11 is performed to thereby perform tracking control. As a spherical aberration correction unit 43, a liquid crystal device may be used. A half mirror may be used in place of the polarized beam splitter 6. As the astigmatism generating unit 13, for example, a cylindrical lens may be further used. Astigmatism is given to the luminous flux by the cylindrical lens, thereby detecting a focus error signal using an astigmatic detection method.

The photodetector may detect a tracking error signal using a DPP method or DPD method. The DPP method will be briefly described below.

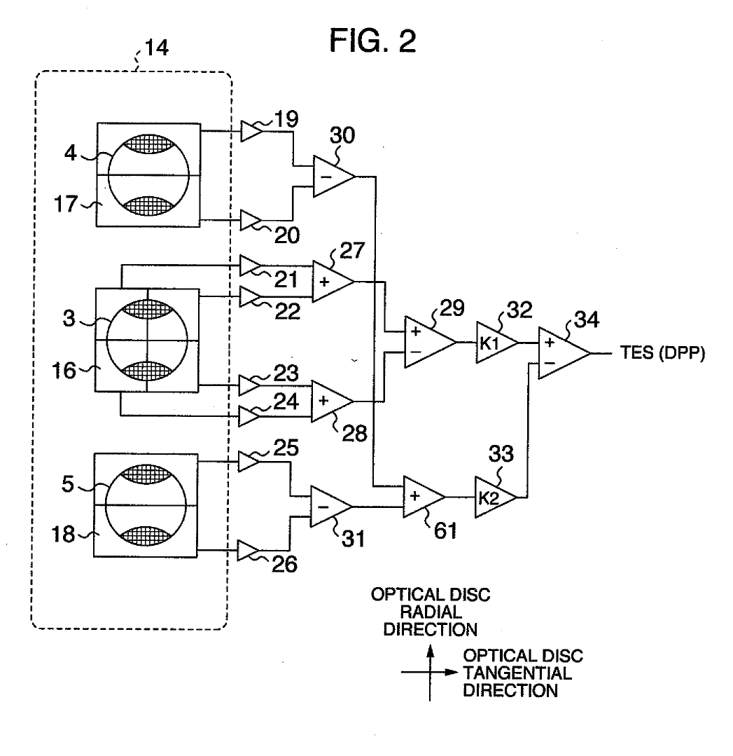

FIG. 2 is a schematic view illustrating a conventional example of the photodetector, and illustrates one example of the DPP detection method. Within the photodetector 14, arranged are one light receiving region which the converged light spot of the main luminous flux reflected by the optical disc enters and another light receiving region which the converged light spot of the sub-luminous flux reflected by the optical disc enters. In these light receiving regions, the main luminous flux light receiving region 16 is constituted by a light receiving surface that is divided into four sections by two dividing lines approximately orthogonal to each other. Meanwhile, each sub-luminous flux light receiving region 17 and 18 is constituted by a light receiving surface that is bisected by a dividing line approximately orthogonal to a direction corresponding to the radial direction of the optical disc. In FIG. 2, a direction corresponding to the radial direction of the optical disc on the photodetector 14 is illustrated by an arrow (in the vertical direction of FIG. 2). A current is generated from each divided light receiving surface according to intensity of incident light and independently converted to voltage by each current-voltage conversion amplifier 19 to 26. Thereafter, the optical disc apparatus that receives signals from the current-voltage conversion amplifiers 19 to 26 performs an adding processing by adders 27 and 28, and performs a subtracting processing by a subtracter 29, thereby outputting a push-pull signal of the main luminous flux 3 (for simplicity, hereinafter referred to as a main PP signal). The optical disc apparatus performs a subtracting processing by subtracters 30 and 31, and performs an adding processing by an adder 61, thereby outputting a push-pull signal of the sub-luminous flux for simplicity, hereinafter referred to as a sub PP signal).

In general, the main luminous flux and the sub-luminous flux are irradiated onto the optical disc keeping a distance of half track, and the two sub-luminous fluxes are irradiated onto the optical disc keeping a distance of one track. Accordingly, the main PP signal and the sub PP signal are output while the phases of signals are shifted by 180 degrees from each other. Therefore, both of the main PP signal and the sub PP signal are amplified by respective appropriate amplification factors K1 and K2 using the amplifiers 32 and 33, and then, subtracted using the subtracter 34. This makes it possible to remove unnecessary direct current components or disturbance components with the same phase included in both of the main PP signal and the sub PP signal and obtain the DPP signals as preferable tracking error signals. An illustration will be omitted, and when photo-detection sensitivity of the sub-luminous flux light receiving surface of the photodetector is set to be higher than that of the main luminous flux light receiving surface, a predetermined signal may be amplified also in the photodetector.

As described above, using the simple optical system structure, the DPP method can remove an offset of the tracking error signal that involves a tracking displacement of the objective lens and stably detect the tracking error signal with high quality. In addition, the DPP method is a widely-used detection method in terms of usefulness.

As to an objective lens position control, the optical pickup device performs a position control in the tracking direction as well as a focus position control as a position control along the optical axis direction. As an error signal detection method for use in this focus position control, an astigmatic detection method is widely used in general. In the same manner as in the tracking control, a predetermined arithmetic processing is performed to detection signals from each light receiving surface of the photodetector illustrated in FIG. 2 to thereby detect a focus error signal. Since information recorded on the optical disc is read out by the change of the total light amount of the main luminous flux 3, a change in the signals (for simplicity, hereinafter referred to as an information reproduction signal) of the sum of output signals from the current-voltage conversion amplifiers 21 to 24 may be viewed.

However, when this DPP method is used for the optical pickup device or optical disc apparatus that records and/or reproduces data onto and/or from an optical disc in which recording layers are multilayered, there newly arises the following problem.

When recording and/or reproducing data onto and/or from the multi-layer optical disc, the optical disc apparatus converges each luminous flux on the recording layers (hereinafter, referred to as a target layer) to be recorded or to reproduce signals among respective recording layers to detect its reflected light. On this occasion, a part of the light amount fails to be reflected by the target layer and is reflected by recording layers (hereinafter, referred to as the other layers) except the target layer. The luminous fluxes from the other layers follow an optical path nearly the same as that of the signal luminous flux from the target layer and enters each light receiving surface within the photodetector to become an unwanted luminous flux that prevents the signal luminous flux from being correctly detected.

This unwanted luminous flux optically causes interference with original signal luminous flux and generates interference fringes on the light receiving surface. A bright-dark pattern of the interference fringes disturbs the light amount balance on each light receiving surface to become an unwanted disturbance component and exerts an influence on the output signals from each light receiving surface. As a result, the unwanted disturbance component causes large deterioration in the recording or reproduction quality.

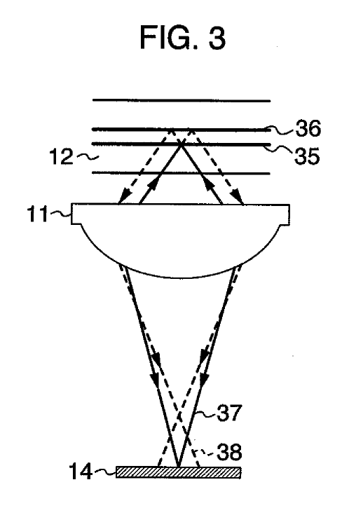

At first, as a conventional example, this phenomenon will be specifically described by a dual-layer optical disc having two recording layers (layer spacing: δ) 35 and 36. FIG. 3 is a schematic view illustrating an optical path of a luminous flux made incident on a dual-layer optical disc, and illustrates a state where the main luminous flux 3 and the sub-luminous fluxes 4 and 5 are converged on a dual-layer optical disc from the lower side of FIG. 3. In addition, FIG. 3 schematically illustrates the main luminous flux 3 and the sub-luminous fluxes 4 and 5 as the signal luminous flux 37 as a whole. FIG. 3 illustrates a case where each luminous flux is converged on a recording layer 35 (case where the recording layer 35 serves as a target layer). In this case, a part of the light amount of the luminous flux converged on the target layer is transmitted to the target layer and reflected by a posterior recording layer 36 to become an unwanted luminous flux 38. This unwanted luminous flux 38 follows nearly the same optical path as that of the original signal luminous flux 37 and reaches the photodetector 14. Note, however, that the unwanted luminous flux 38 and the original signal luminous flux 37 largely differs from each other in a spot size on the photodetector surface due to a difference between focal positions. Thus, in the dual-layer optical disc, the unwanted luminous flux is superimposed onto the signal luminous flux on each light receiving surface to cause interference. A bright-dark pattern of interference fringes caused by this interference disturbs a balance of the light amount detected by each photodetector, and causes fluctuation in the output signals. Particularly, an illustration will not be repeated, but a case where the recording layer 36 serves as the target layer is also in the same manner as in the above description. The luminous flux is transmitted to the anterior recording layer 35 and then converged on the recording layer 36; however, a part of the light amount is reflected by the recording layer 35 at this time to become an unwanted luminous flux.

The sub PP signal for use in the detection of the tracking error signal using the DPP method is generally smaller than the main PP signal in the signal intensity. Accordingly, the light amount of the unwanted luminous flux is larger than that of the sub-luminous flux signal luminous flux, and therefore, the sub PP signal is easy to come under the influence of disturbance. Particularly, the problem is that when generating the tracking error signal using the DPP method, since the sub PP signal is amplified by the amplifier 33, the disturbance components caused by interference of the unwanted luminous flux are also amplified. As a result, the tracking error signal detected by the DPP method_includes a large waveform distortion or fluctuation, and signal quality is largely deteriorated.

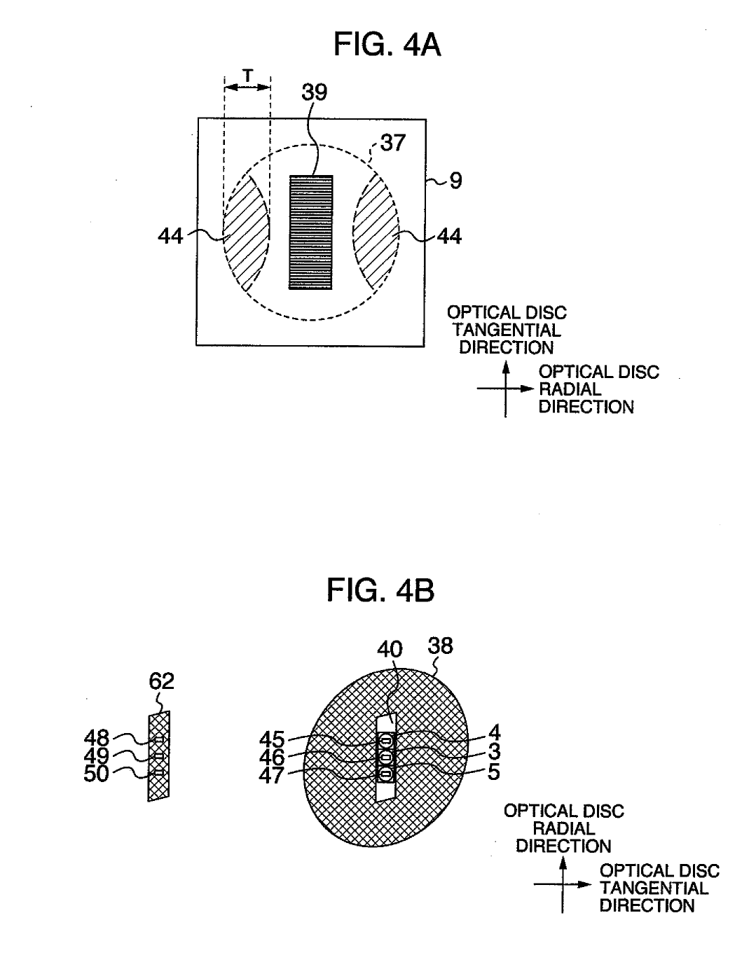

To cope with the above-described problem, the diffractive optical element 9 including a diffraction region for diffracting a part of the main luminous flux and the sub-luminous flux is used in the conventional example described in Patent Document 1 to suppress stray light interference. Hereinafter, a structure of this conventional example will be briefly described. FIG. 4A is a schematic view illustrating one example of a shape of a diffraction region 39 of the diffractive optical element in the conventional example. At the same time, FIG. 4A illustrates a shape of an effective luminous flux of a signal luminous flux 37 passing over the diffraction region surface and a PP signal region 44 in the luminous flux. Next, FIG. 4B is a schematic view illustrating a light intensity distribution of a signal luminous flux and an unwanted luminous flux on the photodetector surface at the time when the optical pickup device described in FIG. 1 mounting the diffractive optical element of the conventional example records and/or reproduces data onto and/or from the dual-layer optical disc. A region 40 (hereinafter, referred to as an unwanted luminous flux dark region) where light intensity is extremely low and where a luminous flux passing through the diffraction region 39 of the diffractive optical element 9 receives a diffraction operation is generated within a spot of the unwanted luminous flux.

In the conventional example, the oblong diffraction region analogous to a shape of the photodetector 14 is formed on a central part of the effective luminous flux, and the unwanted luminous flux dark region 40 with a shape analogous to that of the photodetector is formed on a part overlapping with the photodetector in the unwanted luminous flux. This makes it possible to suppress the unwanted luminous flux from entering the photodetector and reduce deterioration in the tracking error signal. In addition, unwanted luminous flux diffracted light 62 diffracted by the diffraction region 39 of the diffractive optical element 9 is irradiated onto the outside of the photodetector. Similarly, the main luminous flux and the sub-luminous flux as a signal luminous flux also forms signal luminous flux dark regions 45, 46, and 47 each having no light amount using the diffractive optical element 9, and its diffracted light is irradiated onto the outside of the light receiving surface to thereby form diffracted light spots 48, 49, and 50.

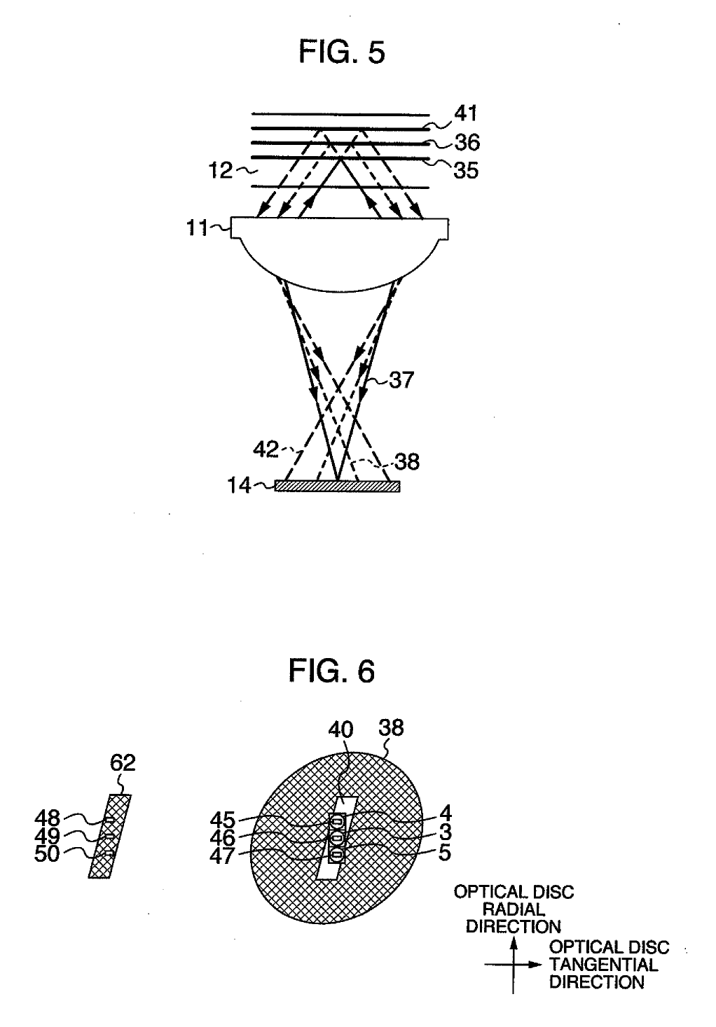

At present, a Blu-ray disc (hereinafter, referred to as BD) or DVD has a standard of the dual-layer optical disc, and therefore, the conventional example is effective in the dual-layer optical disc. However, in recent years, a multi-layer optical disc in which a further increase in the storage capacity is designed and that has three or more recording layers is watched. Next, a case of recording and/or reproducing data onto and/or from this multi-layer optical disc will be described with reference to FIG. 5. FIG. 5 is a schematic view illustrating an optical path of a luminous flux made incident on the multi-layer optical disc, and illustrates a state where a signal luminous flux 37 is converged from a lower side of FIG. 5 on an optical disc having three recording layers 35, 36, and 41 (layer spacing: δ1 and δ2) on one side. FIG. 5 illustrates a case where the recording layer 35 serves as a target layer. In this case, a part of the light amount of the luminous flux converged on the target layer is transmitted to the target layer and reflected by the recording layers 36 and 41 to become unwanted luminous fluxes 38 and 42. As described above, since an unwanted luminous flux is newly generated on the multi-layer optical disc also by the newly-provided recording layer 41, a plurality of the unwanted luminous fluxes are superimposed several times over the photodetector surface, and as a result, an influence of interference is complicated. In addition, a relative intensity of the signal luminous flux to the unwanted luminous flux is reduced. Thus, the influence degree of disturbance caused by interference to the detection signals remarkably increases and quality of the tracking error signal is largely deteriorated. Particularly, an illustration will not be repeated, but much the same is true on a case where the recording layers 36 and 41 serve as a target layer.

At this time, when the layer spacings δ1 and δ2 are at the same level as that δ of the dual-layer optical disc, stray light can be avoided using a structure of the conventional example. However, at the time of multilayering the optical disc, when a layer spacing (hereinafter, referred to as an adjacent layer spacing) of adjacent layers is set to be the same as that of the dual-layer optical disc, a layer spacing (hereinafter, referred to as a maximum layer spacing) between a recording layer nearest to a disc surface and a recording layer farthest to a disc surface remarkably becomes large. Since a difference between cover layer thicknesses causes an aberration that deteriorates quality of a converged light spot on a recording surface, the recording or reproduction quality is largely reduced. For the purpose of correcting the aberration that occurs due to a difference between the cover layer thicknesses, a BD dual-layer optical disc having a recording layer spacing of 25 μm generally mounts the spherical aberration correction unit 43. When a thickness of this cover layer increases by a factor of two due to the multilayer, an aberration correction range is largely widened, and therefore, the optical system becomes larger and more complex and incurs a cost increase. Accordingly, the necessity of multilayering the recording layer increases in the multi-layer optical disc while making the adjacent layer spacing narrower than that of the conventional dual-layer optical disc. When the maximum layer spacing of the dual-layer optical disc is maintained also in the multi-layer optical disc, the adjacent layer spacing is supposed to need to be narrowed up to approximately half of the maximum layer spacing in the three-layer optical disc or approximately 30% of the maximum layer spacing in the four-layer optical disc.

When the adjacent layer spacing is narrowed in the multi-layer optical disc, there newly arises the following problem. FIG. 6 is a schematic view illustrating a light intensity distribution on the photodetector surface of the unwanted luminous flux generated from adjacent layers in the optical pickup device of the conventional example when the adjacent layer spacing of the multi-layer optical disc is set to be approximately half of that of the dual-layer optical disc. When the adjacent layer spacing is narrowed, a spot diameter of the unwanted luminous flux is reduced to increase the light amount density as well as to generate a large distortion in the unwanted luminous flux shape. This is affected by an astigmatism generating unit provided for detecting the focus error signal using an astigmatic detection method. Accordingly, a shape of the dark region 40 within an unwanted luminous flux spot also is largely distorted and the unwanted luminous flux enters the photodetector in the multi-layer optical disc of the conventional example. In this state, interference is generated again between the signal luminous flux and the unwanted luminous flux, and fluctuation is generated in the detection signals.

As a method for avoiding the problem, a width in the direction corresponding to the optical disc radial direction of the oblong diffraction region 39 is enlarged. By use of the above-described method, a region of the unwanted luminous flux dark region 40 on the photodetector can also be widened and the unwanted luminous flux can be prevented from entering the photodetector surface. However, here, the problem is the following. That is, when the oblong diffraction region of the conventional example is enlarged as it is, the diffraction region acts also on the signal luminous flux. Therefore, light of the PP signal region 44 required for detecting the tracking error signal is also diffracted to exert a harmful influence on the signal quality.

To cope with the above-described problem, in the present embodiment, as a method for solving the problem peculiar to the multi-layer optical disc, provided is the diffractive optical element 9 with a diffraction region shape in which also when the unwanted luminous flux shape is largely distorted in the multi-layer optical disc having narrowed therein the adjacent layer spacing, the unwanted luminous flux is prevented from entering the photodetector and an influence on the signal luminous flux of the PP signal region is suppressed. A shape of the PP signal region 44 of the signal luminous flux 37 is first characterized by the fact that the region width T in the optical disc radial direction changes corresponding to a position in the optical disc tangential direction as illustrated in FIG. 4. As the PP signal region 44 is located nearer to the center of the signal luminous flux 37, the region width T in the optical disc radial direction is wider. Meanwhile, as the PP signal region 44 is located nearer to the peripheral part, the region width T in the optical disc radial direction is narrower. Next, when taking into consideration a shape of the unwanted luminous flux on the photodetector surface in the case of the multi-layer optical disc, since the unwanted luminous flux is distorted in an oblique direction, light at a position of the peripheral part distant from the center of the unwanted luminous flux enters the light receiving surface of the photodetector. Accordingly, both have something in common and a shape of the diffraction region of the diffractive optical element may be adopted based on the above-described fact. Based on the above-described fact, the region width in the optical disc radial direction of the diffraction region 39 is taken into consideration. It is known that the diffraction region shape provided on the diffractive optical element 9 is strip-shaped, and when the diffraction region width in the optical disc radial direction in the central part of the diffractive optical element is set to S1 and the diffraction region width in the optical disc radial direction in the peripheral part of the diffractive optical element is set to S2, if the S1 is narrower than the S2, the unwanted luminous flux can be suppressed from entering the photodetector while avoiding deterioration in the PP signal. That is, a width in the direction corresponding to the optical disc radial direction of the diffraction region is narrow in the central part as compared with the peripheral part of the diffractive optical element. In other words, a width in the optical disc radial direction of the diffraction region located in the peripheral part of the luminous flux is wider than that in the optical disc radial direction of the diffraction region located in the central part thereof.

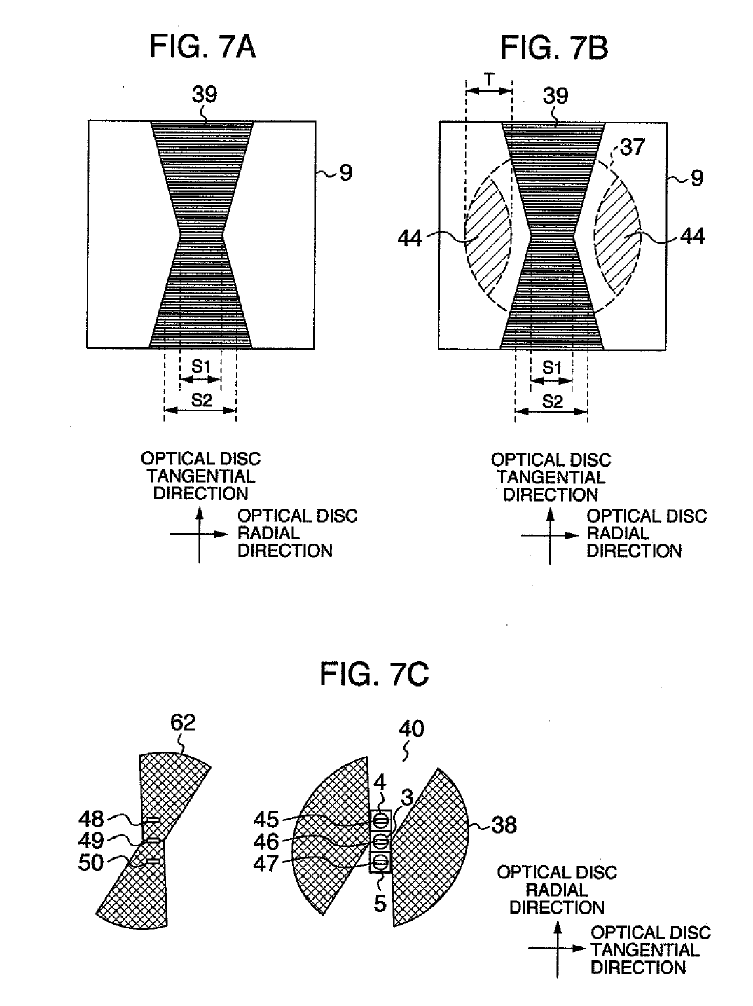

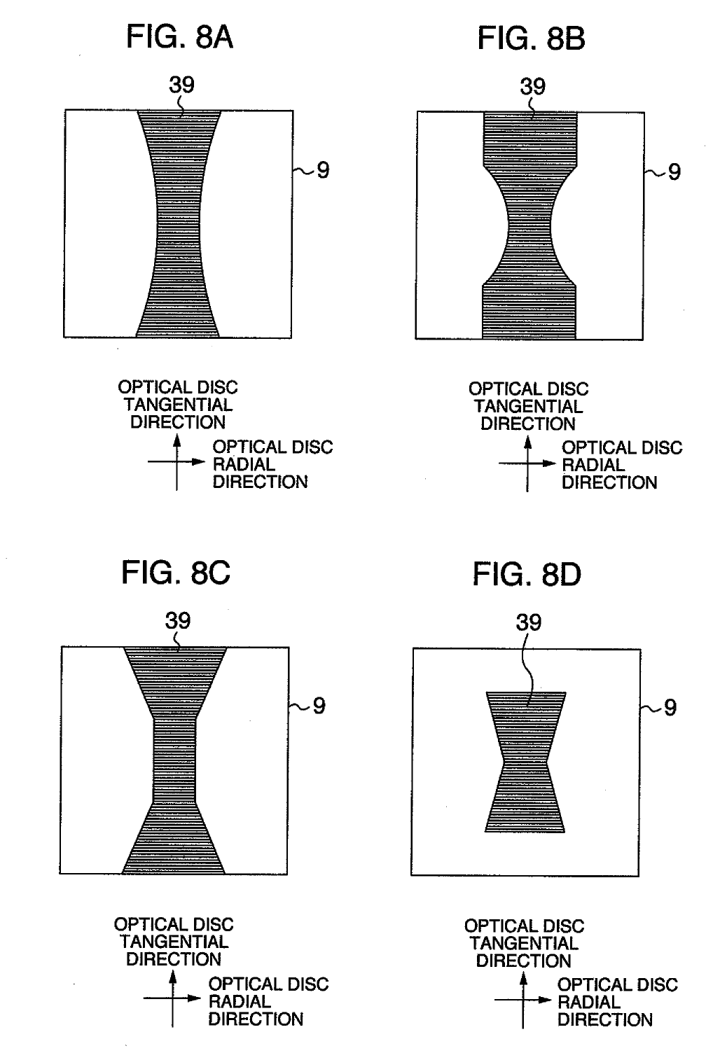

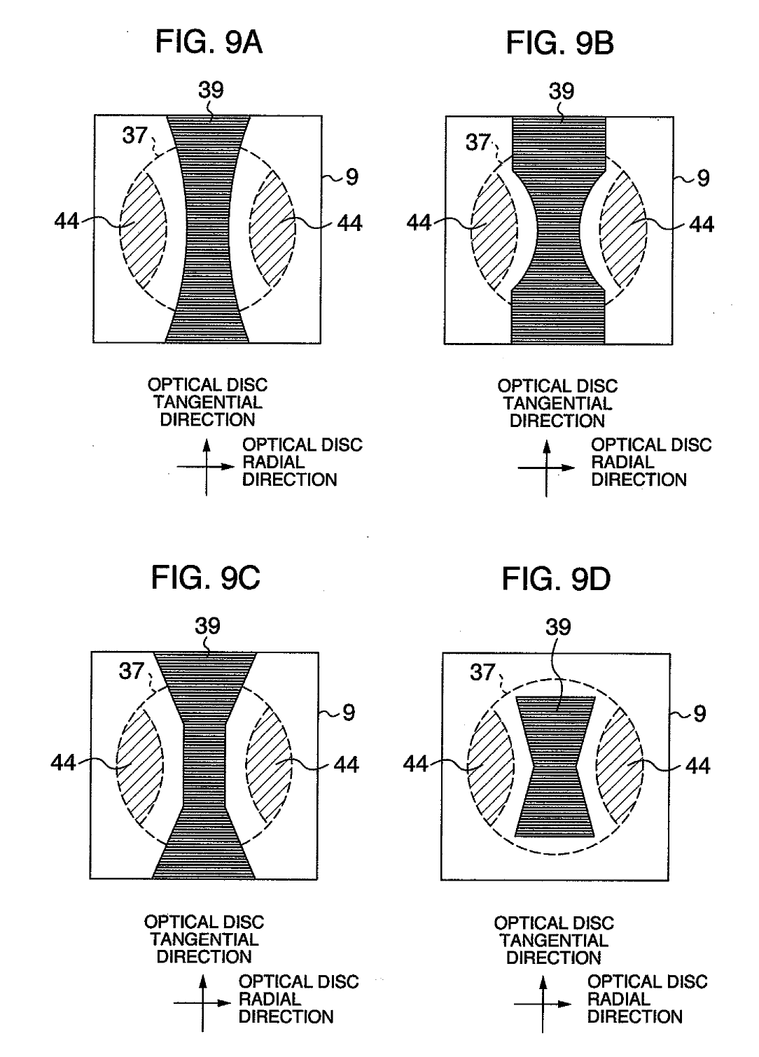

FIG. 7A illustrates one example of the diffraction region satisfying the conditions. The width S1 of the central part and the width S2 of the peripheral part satisfy a relational expression S1<S2. FIG. 7A illustrates an example where a width in the direction corresponding to the radial direction more increases as nearer to the peripheral part. FIG. 7B is a schematic view in which the PP signal region 44 is collectively written in the diffractive optical element in FIG. 7A. It is known that the diffraction region is formed so as not to exert an influence on a region of the PP signal component required for detecting the tracking error signal. FIG. 7C illustrates the light intensity distribution of the unwanted luminous flux and the signal luminous flux on the photodetector surface in the case of the multi-layer optical disc when using this diffractive optical element. It is known that in the multi-layer optical disc, the unwanted luminous flux whose shape is obliquely distorted is effectively prevented from entering into the photodetector. In the present embodiment, this makes it possible to remove the unwanted luminous flux while leaving the PP signal component and largely reduce fluctuation of the tracking error signal also in the multi-layer optical disc in which the adjacent layer spacing is narrowed. Also in the multi-layer optical disc, preferable recording or reproduction quality can be obtained. Much the same is true on a case of applying the present embodiment to the multi-layer optical disc_having four or more layers. FIGS. 8A to 8D illustrates several typical examples of the diffractive optical elements 9 each having the diffraction region shape that satisfies the conditions. In any case, patterns that satisfy the condition of S1<S2 are illustrated. FIGS. 9A to 9D are schematic views in which the PP signal regions 44 are collectively written in the diffractive optical elements in FIGS. 8A to 8D. It is known that the diffraction region is formed so as not to exert an influence on the PP signal region 44 required for detecting the tracking error signal. When the conditions of S1<S2 are satisfied particularly as illustrated in FIG. 8D, the width of the diffraction region in the optical disc tangential direction is not needed to be larger than a diameter of the signal luminous flux. In addition, when satisfying the conditions, the diffraction region shape is not limited to the patterns illustrated in FIGS. 8A to 8D.

Since the unwanted luminous flux rotates at an angle of 90 degrees in the obliquely-distorted direction based on whether the other layers are located on an in-focus side or on out-focus side, the diffraction region shape 39 of the diffractive optical element 9 may be nearly line-symmetrical with respect to the optical disc tangential direction. The diffraction region 39 may be transformed according to a shape of the photodetector. On this occasion, the diffraction region shape 39 may be determined by taking into consideration a shape in which an unwanted luminous flux spot is distorted and PP signal region in the effective luminous flux in the multi-layer optical disc. As the diffraction region of the diffractive optical element, for example, a diffraction grating or polarization diffraction grating may be used. The polarization diffraction grating acts, when used as the diffraction region, only on an incoming luminous flux after the reflection from the optical disc and fails to exert an influence on a spot shape on the optical disc. A spectral ratio of the diffraction region 39 may be variedly set, and the light amount of 0th-order diffracted light may be minimized to reduce the light amount of the unwanted luminous flux dark region 40 as much as possible. In addition, gratings of the unwanted luminous flux dark region 40 may be blazed. When the quarter wave plate 10 and the diffractive optical element 9 are installed within the actuator 15, the proposed optical pickup device can suppress the unwanted luminous flux dark region 40 from moving on the photodetector 14 to the objective lens shift. Accordingly, the optical pickup device can suppress the unwanted luminous fluxes 38 and 41 from entering the photodetector 14 at the time of the objective lens shift. Further, when the quarter wave plate 10 and the diffractive optical element 9 are integrated to treat the integrated components as one optical component, assembly and adjustment can be more simplified.

Each signal luminous flux dark region 45, 46, and 47 having no light amount is formed also in the main luminous flux and sub-luminous flux as the signal luminous flux as described above, and its diffracted light is irradiated onto the outside of light receiving surface to form each diffracted light spot 48, 49, and 50. Therefore, an information reproduction signal obtained from the main luminous flux light receiving surface 16 might be deteriorated. To cope with the above-described problem, an exclusive light receiving surface 51 is newly provided within the photodetector, and the light amount of the main luminous flux diffracted by the diffractive optical element 9 is also detected. A current signal is generated from the exclusive light receiving surface 51 according to the intensity of incident light and converted into a voltage signal by the current-voltage conversion amplifier 69. The converted signal is added to an information reproduction signal obtained from the main luminous flux light receiving surface 16, thereby preventing deterioration in the information reproduction signal. If gratings of the diffraction region are blazed, one exclusive light receiving surface may be newly added. This makes it possible to obtain preferable information reproduction signals in which jitter values are improved.

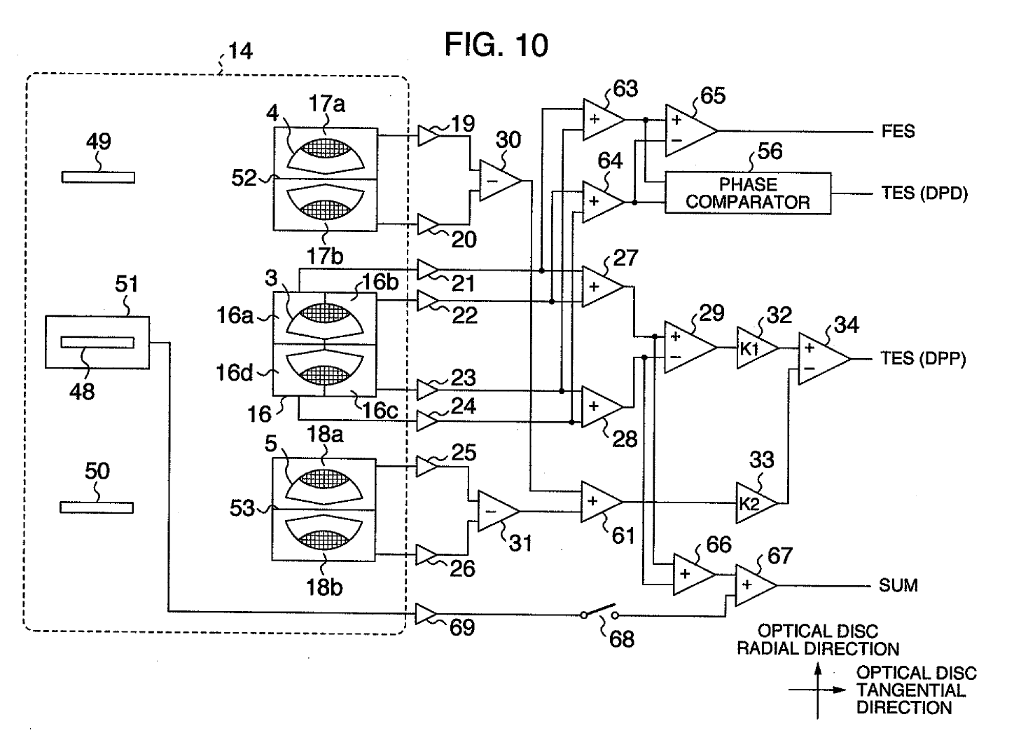

Next, FIG. 10 illustrates one example of a pattern on the light receiving surface and arithmetic method for generating a focus error signal and tracking error signal of the photodetector 14 illustrated in the present embodiment.

Here, the main luminous flux light receiving surface 16 is divided into four respective divided regions 16a, 16b, 16c, and 16d, and the light amount signals each obtained from the respective divided regions are denoted as A, B, C, and D. Further, the sub-luminous flux light receiving surface 17 is divided into respective regions 17a and 17b, and the sub-luminous flux light receiving surface 18 is divided into respective regions 18a and 18b, and the light amount signals each obtained from the respective divided regions are denoted as I, J, K, and L. Further, the light amount signal obtained from the exclusive light receiving surface 51 is denoted as R. The focus error signal (FES) detected by the astigmatism method is obtained by the calculation of

FES:(A+C)−(B+D)
using adders 63 and 64 and a subtracter 65. Note, however, that a detection method of the focus error signal is not limited to the astigmatism method; further, other methods such as a knife-edge method and a differential astigmatism method may be used. When using the differential astigmatism method, one dividing line is formed on the sub-luminous flux light receiving surface in the direction corresponding to the optical disc tangential direction and a four-divided light receiving surface may be structured. The tracking error signal (TES) detected by the DPP method is obtained by the calculation of

TES(DPP):k1[(A+B)−(C+D)]−k2[(I−J)+(K−L)].

The tracking error signal (TES) detected by the DPD method is obtained from a phase comparator 56 by phase-comparing two signals of

TES(DPD):(A+C)and(B+D).

The information reproduction signal (SUM) is obtained by the calculation of

SUM:A+B+C+D+R
using adders 66 and 67.

When a predetermined switching unit 68 selects whether to receive light diffracted by the diffractive optical element to add its received light signal to a signal, a function of the photodetector according to the present embodiment can be combined with that of the conventional photodetector. This makes it possible to select the function corresponding to the number of the recording layers of the optical disc to be recorded or reproduced, and improve flexibility of the optical pickup device. Further, when the exclusive light receiving surface 51 is divided to detect signals, the signals may be added also to the tracking error signal or focus error signal to detect signals.

### Embodiment 2

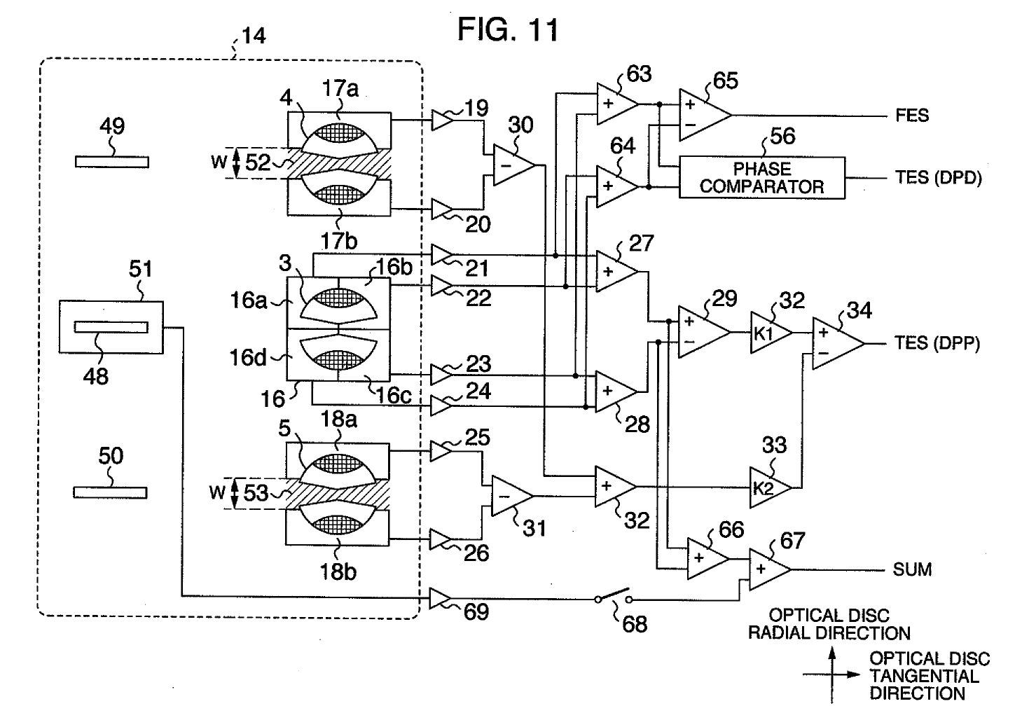

Next, a second embodiment will be described with reference to FIG. 11. In the present embodiment, provided is the optical pickup device in which an interference fluctuation suppression effect according to the first embodiment is further improved and yield can be improved. An optical system structure of the optical pickup device according to the present embodiment may be the same as that of the optical pickup device illustrated, for example, in FIG. 1. A point different from FIG. 1 is a pattern of the light receiving surface within the photodetector 14. Consequently, FIG. 11 illustrates a structure of the photodetector 14 as a principal part according to the second embodiment.

As a result of geometric-optical investigation, when the diffractive optical element 9 according to the first embodiment is provided, the unwanted luminous flux seems to be prevented from entering the photodetector. However, as a result of wave-optical investigation, the light amount slightly leaks also in a dark region to generate interference with the signal luminous flux, and the interference could be factors to cause fluctuation in the tracking error signal. To cope with the above-described problem, as a result of the wave-optical investigation on an influence exerted on the sub PP signal by the interference generated between the unwanted luminous flux and the signal luminous flux, the present inventors have found that among imbalances of the light amount caused by the interference, an imbalance of the light amount caused by the interference on the dividing lines 52 and 53 provided within each sub-luminous flux light receiving surface 17 and 18 and in the vicinity thereof as illustrated in FIG. 10 exerts a most harmful influence on the sub PP signal quality.

Further, the diffractive optical element 9 according to the present embodiment may be the same as that of the first embodiment. The light receiving surface pattern of the photodetector 14 according to the present embodiment is characterized by the fact that a width W of a side in the direction corresponding to the optical disc radial direction has stripe-shaped light-shielding zones or dead zones 54 and 55 set to the after-mentioned size on the central dividing lines 52 and 53 and in the vicinity thereof on the sub-luminous flux light receiving surfaces 17 and 18. Variance of an adjustment position and component performance of the photodetector could be factors to cause further increase in a signal fluctuation caused by interference of the unwanted luminous flux. As a result of extensive investigation, the present inventors have found_that by using this structure, also when variance of the component_performance is present, the signal fluctuation caused by interference can be suppressed up to approximately 50% as compared with the first embodiment. Such a significant reduction effect in terms of manufacturing variance and variation per hour has a significant benefit of improvement in the yield at the time of mass production.

FIG. 11 illustrates one example of a pattern on the light receiving surface and arithmetic method for generating a focus error signal and tracking error signal of the photodetector 14 illustrated in the present embodiment. The main luminous flux light receiving surface 16 is divided into four respective divided regions 16a, 16b, 16c, and 16d, and the light amount signals each obtained from the respective divided regions are denoted as A, B, C, and D. Further, the sub-luminous flux light receiving surface 17 is divided into respective regions 17a and 17b, and the sub-luminous flux light receiving surface 18 is divided into divided regions 18a and 18b, and the light amount signals each obtained from the respective divided regions are denoted as I, J, K, and L. Further, the light amount signal obtained from the exclusive light receiving surface 51 is denoted as R. The focus error signal (FES) detected by the astigmatism method is obtained by the calculation of

FES:(A+C)−(B+D)
using_the adders 63 and 64 and the subtracter 65. Note, however, that a detection method of the focus error signal is not limited to the astigmatism method; further, other methods such as a knife-edge method and a differential astigmatic detection method may be used. When using the differential astigmatic detection method, one dividing line is formed on the sub-luminous flux light receiving surface in the direction corresponding to the optical disc tangential direction and the four-divided light receiving surface may be structured. The tracking error signal (TES) detected by the DPP method is obtained by the calculation of

TES(DPP):k1[(A+B)−(C+D)]−k2[(I−J)+(K−L)].

The tracking error signal by the DPD method is obtained by phase-comparing two signals of

TES(DPD):(A+C)and(B+D)
using the phase comparator 56. The information reproduction signal (SUM) is obtained by the calculation of

SUM:A+B+C+D+R
using the adders 66 and 67.

The light receiving surface is covered with a medium in which transmissivity of light is nearly equal to zero, for example, aluminum and incidence of the luminous flux on the light receiving surface is shielded, thereby realizing the light-shielding zone. A light-shielding medium is not limited to a substance in which transmissivity is nearly equal to zero over the total wavelength bands of light, for example, aluminum. As a light-shielding medium, a substance having wavelength selectivity such that transmissivity is nearly equal to zero over a predetermined wavelength band may be used. For example, when the light receiving surface of a predetermined part is eliminated, a signal current is not generated even if a luminous flux enters the photodetector surface of the predetermined part. This enables the dead zone to be realized. The width W of a short side of the light-shielding zone and the dead zone is effectively set in the range of approximately 20 to 40% with respect to a diameter of the converged light spots 4 and 5 of sub-luminous fluxes made incident on the light receiving regions 17a, 17b, and 18a, 18b in terms of elimination of the interference fluctuation of the unwanted luminous flux. In a normal optical pickup device, the converged light spot of the sub-luminous flux on the light receiving surface is most commonly designed to have a diameter of approximately 100 μm. Therefore, the width W may be set in the range of approximately 20 to 40 μm. Note, however, that shapes of the light-shielding zone and the dead zone may not necessarily be strip-shaped.

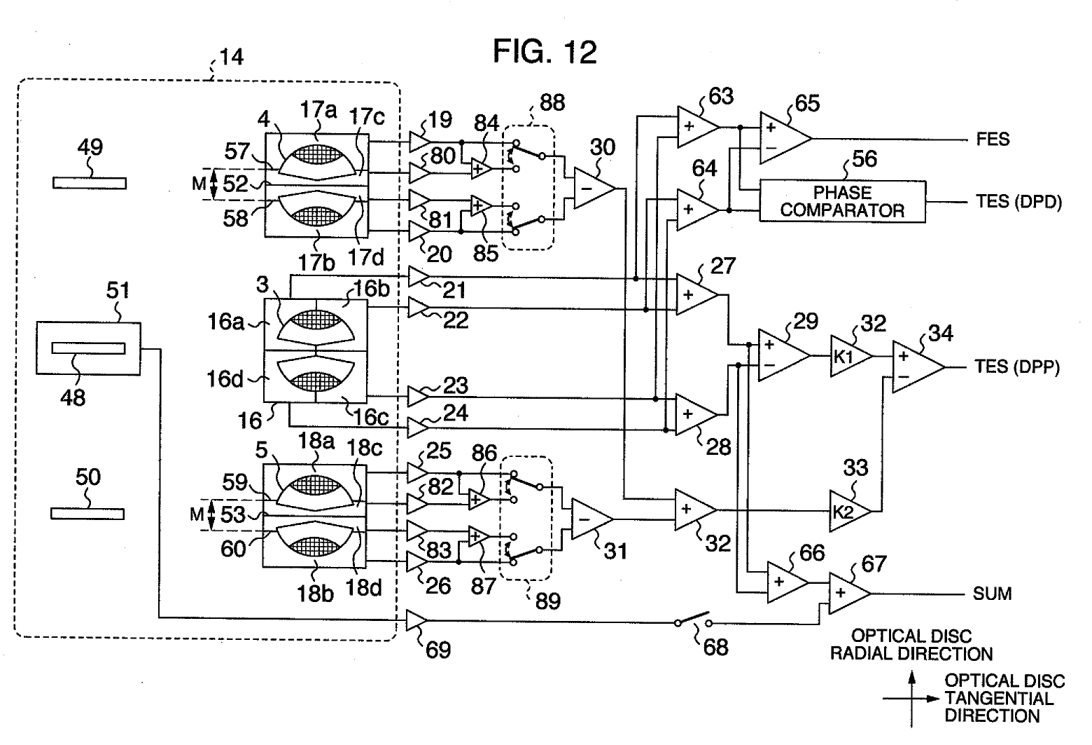

In addition, the photodetector may be structured as illustrated in FIG. 12 in place of forming the light-shielding zone or the dead zone. Above and below the central dividing lines 52 and 53 on the sub-luminous flux light receiving surfaces of the photodetector 14 illustrated in FIG. 12, each dividing line 57 and 58, and 59 and 60 nearly parallel to this central dividing line is newly formed and each sub-luminous flux light receiving surface 17 and 18 is divided into four light receiving regions. The newly-divided light receiving regions on the sub-luminous flux light receiving surface 17 are sequentially defined as light receiving surfaces 17a, 17b, 17c, and 17d. Similarly, the newly-divided light receiving regions on the sub-luminous flux light receiving surface 18 are sequentially defined as light receiving surfaces 18a, 18b, 18c, and 18d. A distance M between the newly-formed dividing lines 57 and 58 as well as 59 and 60 is set to be nearly the same as the width W of the light-shielding zone and dead zone according to the present embodiment. At this time, among signals output from the respective light receiving surfaces via the current-voltage conversion amplifiers 80 to 83, the sub PP signal generated by adding one signal obtained by subtracting signals from the light receiving surfaces 17a and 17d and another signal obtained by subtracting signals from the light receiving surfaces 18a and 18d to each other is the same as that obtained from the photodetector in FIG. 11.

On the other hand, there are generated one signal obtained by adding signals from the light receiving surfaces 17a and 17b, another signal obtained by adding signals from the light receiving surfaces 17c and 17d using adders 84 and 85, another signal obtained by adding signals from the light receiving surfaces 18a and 18b, and another signal obtained by adding signals from the light receiving surfaces 18c and 18d using adders 86 and 87. The sub PP signal obtained from these signals by the same arithmetic processing as that of the above description is the same as the sub PP signal obtained from the conventional photodetector illustrated in FIG. 2. When selecting whether to use output signals only from the light receiving surfaces 17a, 17d, 18a, and 18d, or signals obtained by adding output signals from the light receiving surfaces 17b, 17c, 18b, and 18c to output signals from the light receiving surfaces 17a, 17d, 18a, and 18d for generation of the sub PP signal by a predetermined switching units 88 and 89, functions of the photodetector according to the present embodiment can be combined with those of the conventional photodetector. This makes it possible to select the functions corresponding to the number of the recording layers of the optical disc to be recorded or reproduced and improve flexibility of the optical pickup device.

That is, the present embodiment has the benefit of being able to provide the optical pickup device capable of improving an effect of suppressing an interference fluctuation, suppressing an interference fluctuation also at the time of variance such as component adjustment variance to detect a preferable tracking error signal, and significantly improving a yield also at the time of mass production as compared to the first embodiment.

### Embodiment 3

Next, a third embodiment will be described.

There is a problem that in the DPP method, in order that the sub PP signal with the small light amount may be amplified by the amplifier 33 to generate the DPP signal, an interference disturbance component of the unwanted luminous flux leaking in the sub PP signal is also amplified by the amplifier 33. To cope with the above-described problem, the present embodiment provides the optical pickup device that has a structure in which the amplification factor K2 of the amplifier 33 can be suppressed smaller than that of the conventional DPP method to further suppress an interference fluctuation of the DPP method and have resistance also to a disc defect such as a blemish.

An optical system structure of the optical pickup device according to the present embodiment may be the same as, for example, that of the optical pickup device illustrated in FIG. 1. Further, the diffractive optical element 9 according to the present embodiment may be the same as that of the first embodiment. The light receiving surface pattern of the photodetector 14 may be structured in the same manner as in the second embodiment, and therefore, will be described below with reference to FIG. 12. A point different from the second embodiment is a size of the light-shielding zone width W within the photodetector 14. The light-shielding zone width W according to the present embodiment is determined based on a relationship between the objective lens shift amount L and the width S1 in the optical disc radial direction of the diffraction region on the diffractive optical element 9. In the second embodiment, a size of the light-shielding zone width W is determined in terms of elimination of the interference fluctuation of the unwanted luminous flux. In the present embodiment, the light-shielding zone width is designed to suppress the amplification factor K2 of the amplifier 33 smaller than that of the conventional DPP method, thereby suppressing the amplification of an interference fluctuation component at the time of generating the DPP signal.

A spectral ratio of the diffraction grating 2 as the luminous flux dividing element is generally set to approximately 1:10 to 1:15. Accordingly, since a difference in the light amount is present between the main luminous flux and the sub-luminous flux, the sub PP signal is required to be amplified by the amplifier 33 for generating the DPP signal capable of canceling an objective lens shift offset. Since the two sub-luminous fluxes are present, the amplification factor K2, for example, at the time when a spectral ratio is 1:15 is equal to approximately 7.5 being half of 15. Here, when a fluctuation component Δ caused by the unwanted luminous flux interference is generated on the sub PP signal, the DPP signal is generated by the following formula and therefore, found to be amplified by the amplifier including the fluctuation component Δ caused by interference.

DPP=MPP+K2(SPP+Δ)

Accordingly, when the amplification factor K2 is smaller than a spectral ratio and the DPP signal is capable of cancelling the objective lens shift offset, the optical pickup device can more reduce the interference fluctuation amount relative to the amplitude of the DPP signal. The present writer has estimated that when the amplification factor K2 can be reduced up to approximately 2.5 (normally, K2=approximately 7.5), even if a fluctuation caused by interference with the same amplitude is generated on the sub PP signal, a fluctuation of the DPP signal can be suppressed up to approximately half level of a conventional amplitude. In addition, when suppressing the amplification factor K2 smaller than that of the conventional DPP method, the proposed optical pickup device has the benefit of being able to suppress the amplification exerting an influence on the sub PP signal relative to a disc defect such as scratch and dirt of an optical disc and generate the DPP signal.

Under these conditions, the present embodiment provides a unit capable of suppressing the amplification of an interference disturbance component caused by the unwanted luminous flux by the amplifier 33 and stably detecting a stable and preferable tracking error signal with the reduced waveform fluctuation also at the time of recording and/or reproducing data onto and/or from the multi-layer optical disc when providing a unit capable of preferably canceling an offset generated at the time of objective lens shift even if a value of the amplification factor K2 of the amplifier 33 is smaller than a spectral ratio and detecting a tracking error signal by the DPP method.

The present embodiment uses the diffractive optical element 9 according to the first embodiment and the photodetector 14 having the light-shielding zone and dead zone according to the second embodiment as one example of a unit of preferably detecting the tracking error signal by the DPP method even if the amplification factor K2 of the sub-luminous flux signal amplifier 33 is smaller than a spectral ratio.

As described above, the main luminous flux and the sub-luminous flux forms signal luminous flux dark regions 45 to 47 each having no light amount using the diffractive optical element 9, and its diffracted light is irradiated to the outside of the light receiving surfaces 16 to 18 of the photodetector to thereby form diffracted light spots 48 to 50. A width S′ of a side corresponding to the radial direction of the dark regions 45 to 47 of the signal luminous flux central part is mainly determined by S1.

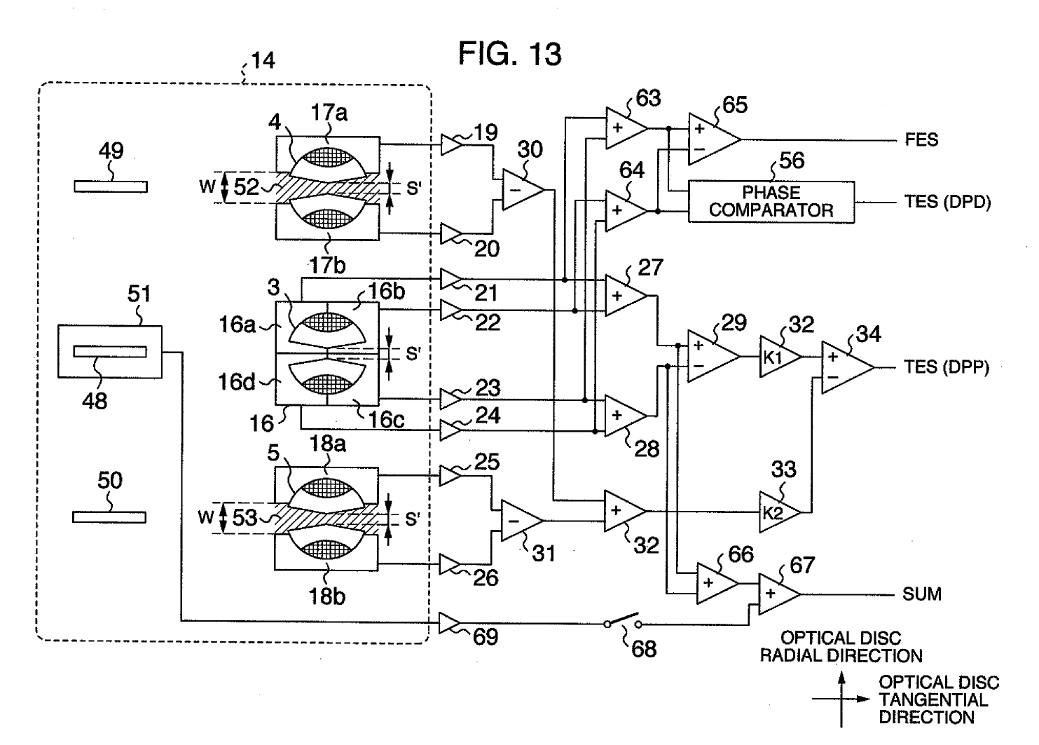

When the objective lens shift occurs, converged positions of the main luminous flux and the sub-luminous flux on the photodetector surface move to the optical disc radial direction (in the vertical direction in FIG. 13). At this time, when the converged light spot of the main luminous flux 3 on the photodetector surface is watched, the luminous flux on the photodetector dividing line is changed to the dark region 45. Even if the converged light spot moves in the radial direction due to objective lens shift, an area of the luminous flux made incident on the photodetector that takes the differential for generating the main PP signal is not changed, and offset to the main PP signal can be prevented from being generated. Note, however, that actually, since an offset component of an optical intensity distribution change due to the objective lens shift is present, the offset is slightly generated on the main PP signal. As a result of extensive investigation, the present inventors have found that when the dark region is provided, the generation amount of the offset can be reduced up to approximately 30% as usual. At this time, when a width of the main luminous flux dark region is not the same at that of the objective lens shift range, some region of the light amount lies on the dividing line, and as a result, the reduction effect of the generation amount of offset is eliminated.

To cope with the above-described problem, an objective lens shift range of the optical pickup device is defined as L, and a converged light spot moving range on the photodetector surface due to the objective lens shift is defined as L′. Relationships between S and S′ as well as L and L′ are uniquely determined by a structure of the optical pickup device. When a width S′ of the diffraction region is larger than the converged light spot moving range L′ on the photodetector surface due to the objective lens shift, namely, when the diffraction region width S1 is larger than the objective lens shift range L, some region of the light amount is prevented from lying on the dividing line, and therefore, the reduction effect of the generation amount of offset at the time of the objective lens shift is exerted. Note, however, that when the diffraction region width S1 is larger than the luminous flux diameter by approximately 50%, the luminous flux on the PP signal region is also diffracted to exert a harmful influence on signals.

Accordingly, when the width S1 of the diffraction region is longer than the objective lens shift range L and within the range shorter than 50% of the luminous flux diameter, it is effective in suppressing the signal offset generated on the main PP signal at the time of the objective lens shift. In general, for example, a ratio of the objective lens shift amount to the luminous flux diameter is approximately 10%. Accordingly, a ratio of the width S1 of the diffraction region to the luminous flux diameter may be in the range of approximately 10 to 50%. By the above-described structure, the main luminous flux dark region lies on the dividing line of the photodetector, and therefore, can largely prevent the offset from being generated over the entire objective lens shift range. As a well-balanced structure in which the offset is prevented from being generated at the time of the objective lens shift and an influence on the amplitude of the PP signal can be reduced, sizes of the diffraction region width S1 and the objective lens shift range L may have nearly the same value.

However, in the above-described structure, since the dark region is generated on the central part also in the sub-luminous flux, the generation amount of the offset is reduced with respect to the objective lens shift in the same manner as in the main luminous flux. For the purpose, the amplification factor K2 is not reduced and, after all, becomes equal to a spectral ratio level. To cope with the above-described problem, a device for increasing an offset generation sensitivity with respect to the objective lens shift is required only in the sub PP signal. The photodetector having provided thereon the light-shielding zones or dead zones 54 and 55 with the width W within the sub-luminous flux light receiving surfaces 17 and 18 may be used. By providing the light-shielding zone, since the dark region in the sub-luminous flux is hidden by the light-shielding zone, an spot area of the sub-luminous flux made incident on each light receiving surface region of the sub-luminous flux photodetector is changed at the time of the objective lens shift, thereby suppressing reduction in the offset generation sensitivity of the sub PP signal. Accordingly, the light-shielding zones having the width W such that the dark regions 46 and 47 of the sub-luminous flux generated by the diffractive optical element 9 are hidden by the light-shielding zones also at the time of the objective lens shift may be provided. In order that the dark regions 46 and 47 may be prevented from running over the light-shielding zones also at the time of the objective lens shift, the light-shielding zone width W taking into consideration also a moving part L′ due to the objective lens shift in addition to the diffraction region width S′ may be adopted. Note, however, that as a result of extensive investigation, the present writer has found that the light-shielding zone width W shields, when being larger than approximately 50% of the luminous flux diameter, also the luminous flux in the PP signal region to exert a harmful influence on the detection signals. Therefore, when the width W of the light-shielding zone is longer than the sum (L′+S′) of the width S′ of the dark region of the sub-luminous flux spot on the photodetector surface formed by the diffraction region having the width S1 of the diffraction region 39 and the moving amount L′ of the sub-luminous flux spot on the sub-luminous flux light receiving surface in the objective lens shift range L and within the range shorter than 50% of a diameter of the sub-luminous flux spot, the offset generation sensitivity of the sub PP signal to the objective lens shift can be increased to be made effective. For example, when a ratio of the objective lens shift amount L to the luminous flux diameter is set to approximately 10%, the moving amount L′ also becomes equal to approximately 10% of the sub-luminous flux spot diameter on the sub-luminous flux light receiving surface. As described above, since a ratio of the width S1 of the diffraction region to the luminous flux diameter is within the range of approximately 10 to 50%, a ratio of the width S′ of the sub-luminous flux dark region is geometric-optically within the range of approximately 10 to 50% of the sub-luminous flux spot diameter on the sub-luminous flux light receiving surface. In this case, a ratio of the light-shielding zone width W to the luminous flux diameter on the light receiving surface is within the range of approximately 20 to 50%. However, when adding a wave-optical effect to the above-described matter, the sub-luminous flux spot has the light amount distribution in the direction narrower than the geometric-optically found width S′ of the dark region of the sub-luminous flux spot. Therefore, the light-shielding zone width W may have a value smaller than the sum (L′+S′) of the geometric-optically found width S′ of the dark region of the sub-luminous flux spot and the moving amount L′ of the sub-luminous flux spot on the sub-luminous flux light receiving surface due to the objective lens shift. When taking into consideration this effective width S″ in the dark region, as a result of extensive investigation, the present writer has found that the light-shielding zone width W may have a value smaller than the sum (L′+S′) by 20 to 40% as a well-balanced structure in which the amplification factor K2 is suppressed smaller than the spectral ratio and an influence on the PP signal amplitude is reduced. Accordingly, when a ratio of the light-shielding zone width W to the sub-luminous flux spot diameter on the light receiving surface is within the range of approximately 10 to 50%, the preferable DPP signal can be obtained over the entire objective lens shift range.

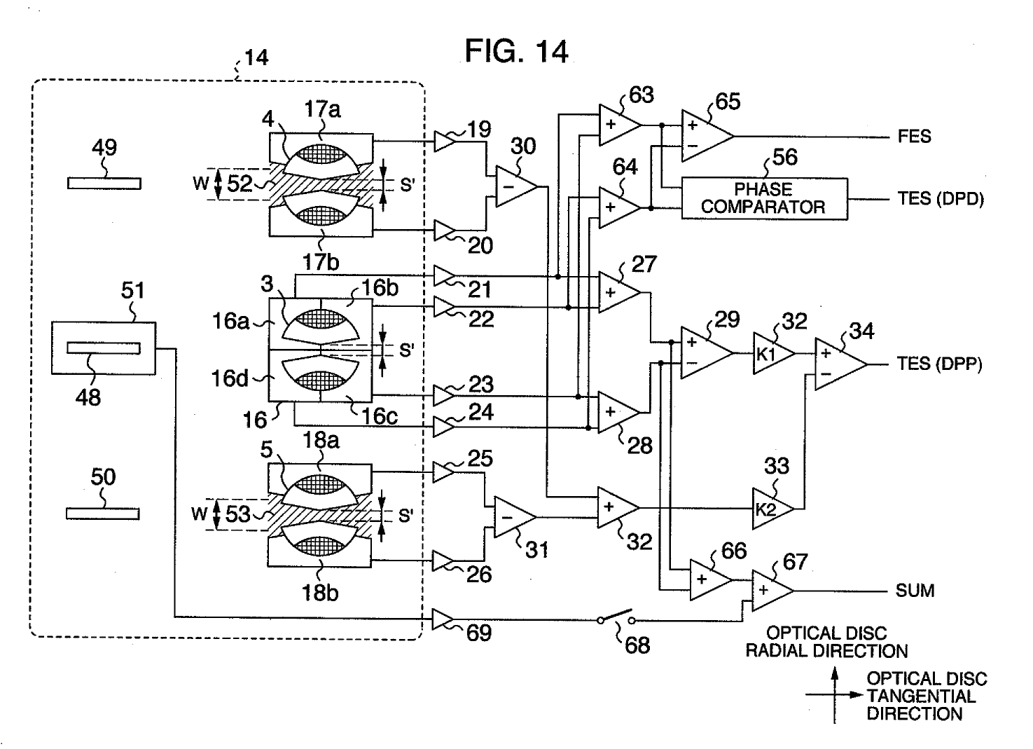

Note, however, that since the diffraction region shape satisfies a relational expression: region width S1<region width S2, a part of the dark region runs over the light-shielding zone. The above-described fact slightly causes an increase in the amplification factor K2. For the purpose of solving the above-described problem, a shape of the light-shielding zone or the dead zone on the light receiving surface may be that analogous to the diffraction region. As one example, FIG. 14 is a schematic view illustrating the photodetector 14 at the time when the diffractive optical element illustrated in FIG. 7 is mounted. In the same manner as in the diffraction region shape, the light-shielding zone width in the optical disc radial direction at the center of the signal luminous flux may be narrower than the light-shielding zone width in the optical disc radial direction in the vicinity of the signal luminous flux.

Further, since the unwanted luminous flux dark region is caused by the diffraction region in the diffractive optical element, the unwanted luminous flux is suppressed from entering the photodetector. Accordingly, the interference suppression effect according to the first embodiment can be maintained.

The generation amount of fluctuation of the sub PP signal is considered, since largely depending also on a variance of a component attaching position or a component performance, to exert a significant influence also on improvement in the yield at the time of mass production.

Further, an operation method for generating a focus error signal, a tracking error signal, and an information reproduction signal from the photodetector 14 according to the present embodiment may be the same as that according to the second embodiment.

That is, the present embodiment can suppress interference of the unwanted luminous flux also at the time of variance such as component adjustment variance and also suppress a disturbance response of the sub PP signal to a disc defect such as scratch since an amplification factor of the amplifier can be reduced as compared with the second embodiment. Therefore, the present embodiment has the benefit of being able to provide the optical pickup device capable of significantly improving a yield at the time of mass production and detecting a preferable tracking error signal also at the time of causing a disc defect.

### Embodiment 4

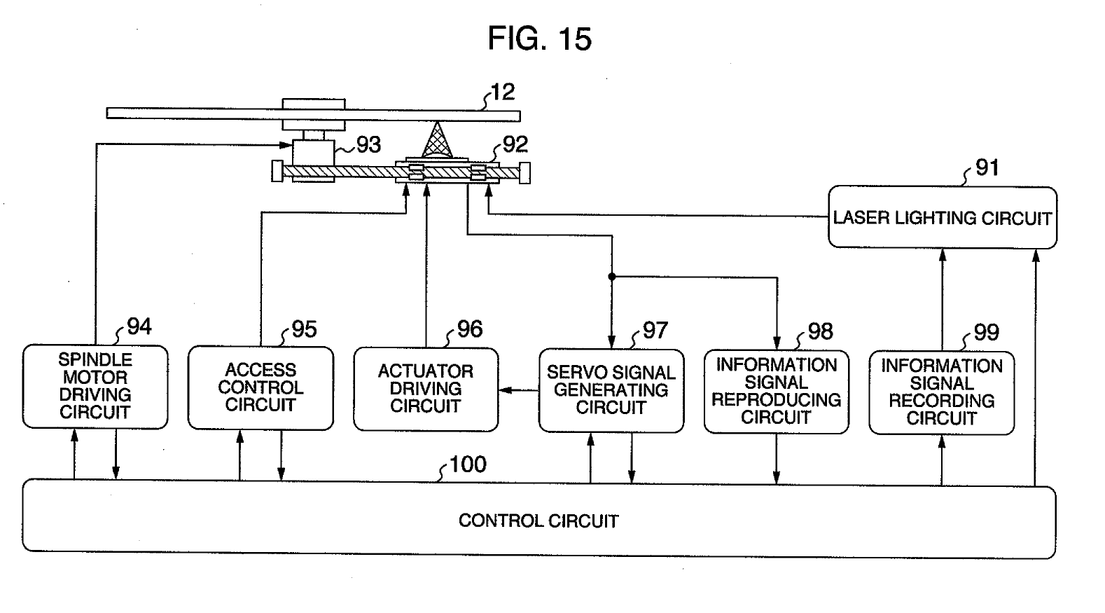

FIG. 15 is a schematic view illustrating an optical disc apparatus having mounted thereon the optical pickup device according to the first to third embodiments. A reference numeral 12 denotes an optical disc, 91 denotes a laser lighting circuit, 92 denotes an optical pickup device, 93 denotes a spindle motor, 94 denotes a spindle motor driving circuit, 95 denotes an access control circuit, 96 denotes an actuator driving circuit, 97 denotes a servo signal generating circuit, 98 denotes an information signal reproducing circuit, 99 denotes an information signal recording circuit, and 100 denotes a control circuit. The control circuit 100, the servo signal generating circuit 97, and the actuator driving circuit 96 control the actuator according to the output from the optical pickup device 92. The output from the optical pickup device according to the present invention is used for the actuator control, thereby performing stable recording or reproducing information with high accuracy. The optical pickup device according to the present invention is not limited to the optical system as illustrated in FIG. 1, the optical system structure, or light receiving surface structure illustrated in the present embodiment. By using each unit, the proposed optical disc apparatus can preferably improve quality reduction of the tracking error signal caused by interference between an original signal luminous flux and an unwanted luminous flux generated from all recording layers except the target layer to be recorded or reproduced and detect the stable tracking error signal with high accuracy when information signals are reproduced from the optical disc in which recording layers are multilayered or recorded on the recording layers.

In addition, the present invention is not limited to the above-described embodiments and includes various modification examples. For example, the above-described embodiments have been described in detail for intelligibly describing the present invention and not necessarily limited to an apparatus including all the described structures. A part of structures according to an embodiment can be substituted for a structure according to another embodiment, and further, a structure according to another embodiment can be added to a structure according to an embodiment. Further, addition, deletion or substitution of another structure can be performed to a part of structures according to each embodiment.

1. An optical pickup device, comprising:
a laser light source;
a luminous flux dividing element that divides a laser luminous flux emitted from the laser light source into a main luminous flux and a sub-luminous flux;
an objective lens that is disposed within an actuator movable in a predetermined direction and converges the main luminous flux and the sub-luminous flux on an optical disc;
a diffractive optical element that includes a region for diffracting a part of the main luminous flux and sub-luminous flux reflected by the optical disc;
an astigmatism generating unit that gives an astigmatism to the main luminous flux and sub-luminous flux reflected by the optical disc; and
a photodetector having a main luminous flux light receiving surface that receives the main luminous flux reflected by the optical disc and a sub-luminous flux light receiving surface that receives the sub-luminous flux reflected by the optical disc, wherein:
a strip-shaped diffraction region is provided on the diffractive optical element; and
a width in the direction corresponding to the optical disc radial direction of the diffraction region is narrow in the central part as compared with a peripheral part of the diffractive optical element.

2. The optical pickup device according to claim 1, wherein:
a polarization diffraction grating is formed on a diffraction region of the diffractive optical element.

3. The optical pickup device according to claim 1, wherein:
the diffractive optical element is disposed on a side nearer to the laser light source than an objective lens within the actuator.

4. The optical pickup device according to claim 1, wherein:
the diffractive optical element is blazed to concentrate light intensity on a predetermined order diffracted light.

5. The optical pickup device according to claim 1, wherein:
a width in the optical disc radial direction of the diffraction region located in a peripheral part is wider than that in the optical disc radial direction of the diffraction region located in a central part of a luminous flux.

6. The optical pickup device according to claim 1, wherein:
a quarter wave plate is provided between the diffractive optical element and objective lens disposed within the actuator.

7. The optical pickup device according to claim 1, wherein:
the photodetector includes a light receiving surface for receiving light diffracted by the diffractive optical element.

8. The optical pickup device according to claim 1, wherein:
the sub-luminous flux light receiving surface is bisected by a dividing line orthogonal to a direction corresponding to an optical disc radial direction, and further, a light-shielding zone for shielding light on the dividing line and in the vicinity thereof or a dead zone in which light on the dividing line and in the vicinity thereof is not detected is formed on the sub-luminous flux light receiving surface.

9. The optical pickup device according to claim 8, wherein:
a width in the direction corresponding to the optical disc radial direction in the light-shielding zone or dead zone region provided within the sub-luminous flux light receiving surface is in the range of 20 to 40% of a converged light spot diameter of the sub-luminous flux irradiated on the sub-luminous flux light receiving surface.

10. The optical pickup device according to claim 1, wherein:
the sub-luminous flux light receiving surface is bisected by a dividing line orthogonal to a direction corresponding to an optical disc radial direction, and further, has a light-shielding zone for shielding light on the dividing line and in the vicinity thereof or a dead zone in which light on the dividing line and in the vicinity thereof is not detected; and
one width in the direction corresponding to the optical disc radial direction of the light-shielding zone or dead zone region and another width of the optical disc radial direction of the diffraction region provided in the diffractive optical element are each set to a predetermined width relative to a length in the range capable of shifting an objective lens.

11. The optical pickup device according to claim 1, wherein:
a diffraction region width of the optical disc radial direction of the diffractive optical element central part is in the range of 10 to 50% of a luminous flux diameter on the diffraction region surface.

12. The optical pickup device according to claim 10, wherein:
a width in the direction corresponding to the optical disc radial direction in the light-shielding zone or dead zone formed within the sub-luminous flux light receiving surface is in the range of 10 to 50% of a sub-luminous flux converged light spot diameter irradiated on the sub-luminous flux light receiving surface.

13. The optical pickup device according to claim 10, wherein:
the light-shielding zone or dead zone formed within the sub-luminous flux light receiving surface is a shape analogous to a diffraction region shape of the diffractive optical element; and
a width in the direction corresponding to the optical disc radial direction of the light receiving surface central part is in the range of 10 to 50% of the sub-luminous flux converged light spot diameter irradiated on the sub-luminous flux light receiving surface.

14. The optical pickup device according to claim 1, including one function of reproducing each information signal recorded on a plurality of recording layers provided at a predetermined distance within the optical disc, and another function of recording each information signal on each recording layer.

15. An optical disc apparatus, comprising:
the optical pickup device according to claim 1, wherein:
a signal amplified by a signal amplifier is a sub PP signal; and
a tracking control is performed by a DPP method.

16. An optical disc apparatus, comprising:
the optical pickup device according to claim 1;
a laser lighting circuit that drives the laser light source in the optical pickup device;
a servo signal generating circuit that forms a focus error signal and a tracking error signal using signals detected by the photodetector in the optical pickup device; and
an information signal reproducing circuit that reproduces an information signal recorded on an optical disc.

17. The optical disc apparatus according to claim 16, including one function of reproducing each information signal recorded on a plurality of recording layers provided at a predetermined distance in the optical disc, and another function of recording each information signal on each recording layer.
